(19) United States
(12) Patent Application Publication
(10) Pub. No.: US 2023/0060139 A1
(43) Pub. Date: Mar. 2, 2023

(54) Other Explanations & Implementations of Solution Automation & Interface Analysis

(71) Applicant: Joni Jezewski, Fremont, CA (US)

(72) Inventor: Joni Jezewski, Fremont, CA (US)

(21) Appl. No.: 17/446,677

(22) Filed: Sep. 1, 2021

(51) Int. Cl. G06Q 10/04; G06Q 10/06

(52) U.S. Cl. CPC G06Q 10/04; G06Q 10/0633

(57) ABSTRACT

Variables relevant to components of solution automation & interface analysis, such as solution automation workflows & their variables as well as function types like core interaction functions & their variables, fit together in various ways, such as how core interaction functions like ‘connect’ are used in solution automation workflows like ‘connect problem & solution’.

Additionally, additional specific example implementations of components of solution automation & interface analysis (like example solution automation workflows) to implement solution automation & interface analysis are included in the specification of this invention.

### FIELD

Embodiments of the disclosure relate to additional variables of components of the inventions “solution automation” & “interface analysis”, as well as example implementation/application methods of variable components like “solution automation workflows”, to implement or apply as configuration/data/code.

### BACKGROUND OF THE INVENTION

Variables relevant to components of solution automation & interface analysis, such as solution automation workflows & their variables, fit together in various ways, which are explained further below for clarity.

The example applications & implementations in this disclosure specify configuration/data/code that can be used to apply/implement the inventions referenced in U.S. patent application Ser. No. 16/887,411 & 17016403.

These examples extend the example applications & implementations referenced in U.S. patent application Ser. Nos. 16/887,411, 17/016,403, 17/301,942, 17/304,552, 17/444,286.

### BRIEF SUMMARY OF THE INVENTION

One or more embodiments of the present disclosure may include a method that involves solution automation & interface analysis variables, like:
function types
   general functions like find/apply/cause/intend/build/mean
   interim cross-interface functions like organize/standardize
   core interaction functions like connect/reduce/combine
   problem-solving intent functions like ‘filter a solution space’
   interface operation functions like ‘apply the causal interface to the pattern interface to find “causes of patterns”’ & interface-query-building functions executing logic like ‘derive multiple interface queries & execute them in parallel until one is clearly contributing, then continue that query’
   vertex functions like generative/describing/determining/causing/differentiating functions
solution automation workflows & their variables (like workflow fit, alternate versions, variable interactions, core/component/differentiating/input/output/vertex variables, interface variables like ‘cause’ and ‘success cause’ and useful structure variables like ‘generative functions of workflows’)
   interface queries implementing solution automation workflows & their variables
useful structures like ‘alternate routes’, ‘generative functions’ & ‘optimizations’
problem/solution structures like ‘error types’ & ‘solution metrics/requirements’

The examples in this disclosure involve explanations of how these variables of solution automation & interface analysis fit together, as well as example implementations or applications of these components.

### BRIEF DESCRIPTION OF THE DRAWINGS

Example embodiments will be described & explained with additional specificity & detail through the use of all of the accompanying drawings in U.S. patent application Ser. No. 16/887,411 & 17016403, which contain diagrams of the relevant program components (like solution automation module 140) where example implementations contained in this specification can be applied as configuration/data/code. The same applies for U.S. patent application Ser. No. 17/301,942 & 17304552 & 17444286, which also offer alternative examples of configuration/data/code of U.S. patent application Ser. No. 16/887,411 & 17016403.

### DETAILED DESCRIPTION OF THE INVENTION

As used herein, terms used in claims may include the definitions & term usage as detailed in U.S. patent application Ser. Nos. 16/887,411, 17/016,403, 17/301,942, 17/304,552, & 17/444,286.
The term ‘implement’ a component indicates intent to ‘build’ a component, like ‘implement a function to reverse a sequence’ indicates ‘build a function to reverse a sequence’.
The term ‘apply’ a component indicates intent to ‘use’ a component, like ‘apply interface analysis’ indicates ‘use interface analysis’.
   The exception to this is where ‘apply’ is used in the context of the core intent function of the invention called ‘apply’, which refers to a specific invention function that ‘applies’ one component to another, like ‘applying an input to a function’, in the sense of ‘injection’ or ‘fitting/merging’.
These definitions are implied/referenced in the other applications & included to avoid conflation.

Interface analysis applied to further explain solution automation & interface analysis This section includes further explanations organizing the components of solution automation & interface analysis, such as how its variables fit together.

There are many variables determining solution automation & interface analysis, such as:
problem-solving intents (like ‘filter a solution space’)
problem structures (like the ‘problem types’ or ‘problem space allowing the problem to occur’)
solution structures (like ‘solutions’ or ‘solution metrics or requirements’)
solution automation workflows (like ‘trial & error’)
structures used in solution automation workflows, interaction structures, or interface queries
   functions (like ‘find’ or ‘connect’)
   interfaces (like ‘change’ or ‘potential’ or ‘intent’)
   problem/solution structures (like ‘solution success cause’ or ‘error structures’)
   interface structures (and specifically useful interface structures) (like ‘optimization’, ‘cross-interface’, or ‘trade-off’ structures)
various interface query implementation variables (like ‘origin interface that the query starts from’)
   These variables fit together according to various rules (like rules describing how ‘various “function types” fit together for different “intents” or for various “interaction levels”’). Some example solution automation variable configuration for various relevant functions, attributes & structures follows, followed by some example solution automation workflow variables (some of which was referenced in other applications).
   These variables fit with basic interaction rules like: ‘one variable applies the other variable’, ‘one variable can generate the other variable’, ‘both variables can generate the other variable’, ‘one variable is an option/requirement for the other variable’, ‘one variable is an interchangeable alternative of the other variable’, etc.

Solution Automation Variable Fit Summary

1. problem/solution structures
solution structures like solution metrics & error structures like error types are useful as components of solution automation workflows
   ‘solution metrics’ are used in the ‘filter a solution space’ problem-solving intent of some solution automation workflows
   ‘error types’ are used in the ‘avoid errors’ problem-solving intent of some solution automation workflows
      2. interfaces
primary interfaces like cause/intent/change
specific interfaces of a problem space (like how ‘intelligence’, ‘incentives’, ‘experience’, & ‘decisions’ are specific interfaces in an agent-based system)
specific problem-solving interfaces like ‘useful structures’ or ‘insights’
specific attribute interfaces like ‘interactivity’ or ‘consistency’ or ‘balance’
   3. useful structures
general useful interface structures: ‘generative functions’, ‘alternate routes’
useful structures of solution automation workflow variables
   ‘generative functions’ of ‘solution automation workflows’
   ‘generative functions’ of ‘solution success cause’

4. solution automation workflows
example: ‘break a problem into sub-problems & merge sub-solutions’
insight paths & other relevant structures to workflows (insight paths include all workflows which ‘make finding solutions easier’, but insight paths generally ‘make finding insights/info easier’ in some way)
   ‘apply cross-system insight patterns to other systems to predict insights’
interface queries: ‘apply causal interface to identify cause of problem and solve alternate problem of “reducing problem cause”’
   5. solution automation workflow attributes
inputs
   ‘solution success cause’
      ‘inputs to info like certainties/energy can be used to generate other info’
position
   ‘related object (workflow) network fit’
      ‘generalization of a workflow’
         6. functions

A. general functions (‘find’, ‘build’, ‘apply’, ‘derive’, ‘mean’, ‘cause’, ‘intend’)
these are associated with primary interfaces:
   find/info, build/core, apply/change, derive/logic, mean/meaning, cause/cause, intend/intent

B. core interaction functions & interaction structures (‘connect’, ‘combination’)

C. interim cross-interface functions (‘organize’, ‘standardize’)
these connect other functions, specifically connecting general functions with interfaces & core interaction functions
   ‘organize’: “find” interface structures “structures” that apply the core interaction function “fit” in a way that fulfills solution metric “consistency”′

D. general problem-solving intent functions (not all intents need to be fulfilled for a given workflow, sometimes fulfilling one intent is enough to qualify as a solution automation workflow if implemented in the right way)
‘filter solution space’
‘relate problem to other problems’

Solution automation variable fit details

What follows are details on how solution automation variables fit together.
In general, these solution automation variables should be able to generate each other once defined
‘interfaces & the structures/operations defined for them’ should be able to generate ‘solution automation workflows’
‘functions’ should be able to generate ‘interfaces’
‘problem/solution structures’ can generate ‘solution automation workflows’ be applying structure to a problem/solution makes it increasingly trivial to solve in cases that can be identified by their structure (like ‘connection’ structures connecting problem/solution structures, leading to the ‘connect problem/solution structures’ workflow)

the variants of each variable should also be able to generate the other variants
a particular solution automation workflow should be able to solve the problem of ‘generating another solution automation workflow’
‘problem-solving intent functions’ should be able to generate ‘general functions’ or ‘core interaction functions’

these variables can generally interact with each other using any interaction function, with particularly useful interactions including:
functions can be ‘components’ of solution automation workflows
solution automation workflows can be ‘components’ of functions (indicating that a workflow should be applied to generate that component)
solution automation workflows can be ‘inputs’ of solution automation workflows
structures are ‘subsets’ of interfaces
structures are ‘alternate formats’ of functions

Solution automation variable fit of primary variables

1. problem/solution structures
these are a reason to use the other structures (‘bc a problem exists, there is a reason to apply workflows to find a solution’)
these structures are found in solution automation workflows which are specifically defined to fulfill useful interactions of problems/solutions
   2. interfaces like the following are useful bc they add value in their potential to find/derive/generate info, and are components of other workflow variables
‘primary interfaces ‘such as cause/intent/change’ can be components of other workflow variables bc they are fundamentally useful concepts with high-variation, that can act as structures/functions
   ‘change a standard solution until it fulfills solution metrics’ is a solution automation workflow that involves the ‘change’ interface
   ‘change the logic steps of a function until it matches function intent’ is a specific function involving the ‘change’ & ‘intent’ interfaces
   ‘structures of change’ on an interface like ‘intent’ are useful bc knowing how structures like ‘intent sequences’ change is useful for predicting their future states & interactions & outputs
‘specific interfaces of a problem space’ can be useful bc interface operations governing interface interactions can be used to predict their interactions
‘specific problem-solving interfaces like “useful structures” or “insights”’ are useful by definition & relevance to problem-solving
‘specific attribute interfaces like “interactivity”’ are useful bc these offer a connection across interfaces to enable efficient interface queries, if these attributes are adjacently applied to input structures
   3. useful structures
general useful interface structures
   ‘generative functions’ are useful bc they apply structure to a primary interface (‘cause’), to create structures that are useful for other intents like ‘generating a structure’, ‘finding a structure’, ‘solving a problem cause’
   ‘alternate routes’ are useful bc they apply structure to a primary interface (‘change’), to create structures that are useful for other intents like ‘connect’
useful structures of solution automation workflow variables
   useful structures of variables related to solution automation workflows are by definition useful for problem-solving automation intents
      ‘generative functions’ of ‘solution automation workflows’ are useful where a new solution automation workflow is required or other workflows can be improved for a particular problem
      ‘generative functions’ of ‘solution success cause’ are useful to identify causes of solution success for use as a filter of solutions or a way to generate default probably successful solution structures like requirements
         4. solution automation workflows
solution automation workflows are useful be they connect input problem info in the form of ‘missing info’ with a solution that provides that missing info in a particular format, and they execute that connection using structures, allowing specific implementations to be constructed that solve the problem
the specific nature of these workflows adds value in guiding the implementation of the workflow, reducing the work required in solving the problem (in the form of reducing the decisions that need to be made, by specifying which structures to apply & fulfill)
   5. solution automation workflow attributes
descriptive attributes of workflows
   solution automation workflows can be described in terms of their:
      relation to other workflows (how they fit with other workflows, as in how to generate them by applying conversions to other workflows)
      standard variations (generalization, simplification)
      start/end point of the workflow (which interface the workflow starts from)
generative variables creating workflows
   any structures that can generate interactions that find/derive/generate info can generate solution automation workflows
      this includes other solution automation workflows, which can be used to generate other solution automation workflows by applying conversions to them in ways that don't invalidate the problem-solving functionality
input variables determining differences across workflows
   workflows depend on some requirements, like:
      relevant structures/formats
      problem/solution structures
      general problem-solving intents
      functions including general functions, interim functions & core interaction functions/structures
      interfaces
   the core abstract function represented (is it a find method, an apply method, a combination)
   the models used (object model, interface query)
   unstructured/uncertain information
      6. functions

A. general functions are used for ‘info existence’ intents
before other functions can be applied, info has to exist (it has to be found, derived, generated, have structure from changes applied to other existing info, or have meaning in order to exist)
   these functions can be used to find/derive/generate/apply/mean info in:
      an interface query:
         a problem type like ‘find structures to solve an “info asymmetry” problem type’
         a specific problem like ‘find a structure’
      a solution automation workflow:
         problems in general like ‘find info to solve info problems’
         problems in a particular general format like ‘find a function’ or ‘avoid errors’ or ‘find connections’
      any function that finds/derives/generates/defines/applies info:
         ‘find a string matching another string’
         ‘find a solution having this attribute’
these functions are interchangeable
   different general functions can be applied to solve a problem, like ‘find a prediction function’
   find: ‘find a prediction function’
   apply: ‘apply changes to prediction function interface structures like prediction function patterns or components until the target prediction function is reached’
   derive: ‘apply interface structures like limits/requirements/errors to derive a prediction function, given what a prediction function is not’
   generate: ‘apply components of prediction functions to build a prediction function by combining/merging components of prediction functions’
   mean: ‘define the meaning of a prediction function (absolutely or in a given context) and filter possible prediction functions based on this definition’

B. core interaction functions & structures (‘connect’, ‘combination’) can be used to specify/structure the implementation of a function
using specific interaction functions/structures creates a specific structural intent to fulfill when implementing a function
   ‘connect a problem/solution’ is more specific & structural than ‘relate a problem/solution’, so using ‘connect’ is useful to get all the useful info associated with the ‘connect’ function, like:
      the definitions of how it can interact with other objects, any related logic already defined for the function, clarity in how it can be applied
         the definition of ‘connect’ implies a sequence of conversions linking states of the input/output, so applying it to a problem/solution indicates that the problem can be connected with the solution using a sequence of conversions
         this provides a specific structure to look for (a ‘sequence of conversion functions’), which is useful info for fulfilling the ‘connect’ intent & implementing the function
      what its useful for, what inputs it can use & what outputs it can produce
         ‘connect’ is useful for intents like ‘equate’, when objects should be equated be they're different by default (a problem is different from a solution)
         ‘connect’ has outputs like a ‘sequence of conversions/states/formats’ and the target output (in this case, the target output is the ‘solution’)
this is generally useful for generating any function automatically
   a requirement to generate functions may occur in an interface query, where sub-problems & corresponding sub-solution intents are identified, and a new function may need to be implemented automatically to fulfill that sub-problem-solving intent
   example: if a component of an interface query such as the intent ‘find the cause of a structure’ is not an existing function, a function will need to be implemented automatically to fulfill that intent in the interface query
      an example of how this would be implemented is a sub-interface query implementing a solution automation workflow that would be called by this interface query if a function is not found for this intent, to solve the problem of ‘missing info’ in the form of a ‘missing function’
         sub-problem: ‘missing info of a function to connect cause & structure’
         sub-problem: ‘missing info about cause’
         apply the ‘connect problem/solution’ solution automation workflow
         output:
         function to connect cause & info about cause:
         ‘connect’ ‘definition’ with ‘cause’
         sub-problem: ‘missing info about the connection between cause & structure’
         apply the ‘connect problem/solution’ solution automation workflow
         output:
         function to connect cause & structure:
         ‘connect’ ‘definition’ of ‘cause’ with ‘structure’
         sub-problem: ‘missing info about specific cause of the original problem structure’
         apply function output by the query above to ‘connect definition of cause with structure’ to the ‘specific structure’ in the original problem
         output:
         ‘specific cause’ of ‘specific structure’ in original problem

C. interim functions are useful for being general enough to allow variation in specific implementations of general useful intents like ‘organize’ or ‘standardize’, while still differentiating these interim functions to identify useful intents in implementing ‘info existence’ intents
‘organize’ helps with the general intent of ‘info having meaning’ (mean), but doesn't specify exactly how to organize info, allowing for variation in implementation according to which structures/functions would optimally implement it in a given usage context
   the variables to this function would include how to fulfill sub/related intents of ‘organize’ like ‘merge’, ‘fit’, ‘connect’
‘standardize’ helps with the general intent of ‘finding info like differences’ (find), but doesn't specific exactly how to standardize info
   the variables to this function would include which interface to standardize to, and how to fulfill sub/related intents of ‘standardize’, like ‘define’, ‘structure’, ‘identify’, ‘differentiate’, ‘connect’
given that general functions like ‘find’/‘apply’ fulfill all ways to solve info problems (which are fundamentally ‘missing info’ problems in some way), and that core interaction structures/functions add value in the form of specific structures to guide function implementation, combining these can fulfill useful interim functions like ‘organize’/‘standardize’ which have many ways to implement them, but are less abstract than general functions & less specific than core interaction structures/functions
these interim functions may be used in any workflow components, but are especially likely to be used in:
   solution automation workflows, as generally useful functions that add value in the info they can create
   interface queries, as more abstract functions to implement in a specific way that is useful for solving that particular problem, which aligns with the structure of an interface query
   interface-enabling functions, so these interim functions would be part of the interface query to implement a function like ‘apply/define an interface’ (if they didn't rely on those functions as inputs)
      ‘apply a standard’, which fulfills interim intents like ‘standardize’ in a specific way (‘apply an interface as a standard’)
      ‘define a standard’, which fulfills interim intents like ‘organize/integrate’ in a specific way (‘organize & integrate structures required to structure/define the specific concept creating a standard like “cause”’)

D. general problem-solving intents like ‘filter a solution space’ can be created from particularly useful general/interim/interaction structures/functions applied to problem/solution structures, useful as determined by the problem/solution structure definitions which indicate how they would optimally interact
‘filter a problem space’ isn't as useful as ‘filter a solution space’ for general problem-solving processes, be ‘filtering a solution space’ has an output of a ‘solution’ by definition of what a ‘filter’ and ‘solution space’ are, whereas ‘filtering a problem space’ wouldn't necessarily have this output
‘relate problem to other problems’ is useful in case solutions to related problems are available, as a source of initial solutions to test, which is useful for some solution automation workflows

General Fit of Solution Automation Function Type Variables

In between the general functions (find/generate/apply/mean) and the core interaction functions (connect, reduce, break, filter), there is an interim level of function interactions that sync with the interface query interaction level (identify, select, cause, standardize, organize, integrate)
similarity in interaction levels indicates various connections across these hierarchies
   solution automation workflows (‘filter solutions by what structures are not known errors’), having various general problem-solving intents (‘filter solutions’, ‘differentiate solutions from errors’)
      interim functions (‘compare/select solutions’)
         structural core interaction functions (‘check if a solution is equal/similar to an error’)
   interface (‘system’)
      interface structures (‘conflict’)
         interface structures on other interfaces (‘intersection’ or ‘diverging direction’ or ‘resource inequality’ on the structural interface)
   hierarchy connections
      interim functions often use interface structures like contradictions be interface structures represent interim structures between the abstract concept defining the interface (like cause or logic) and the structures in other systems that correspond to that interface's structures
general problem-solving intents for solving info problems
   the general functions represent general intents fulfilling the structure ‘information existence’ (in order for info to exist from the perspective of the program, you have to find/derive/generate it)
specific problem-solving intent functions
   functions like ‘filter solution space’ are interactions between structural core interaction functions and problem/solution structures
the interim functions connect the general & core interaction functions
   ‘organize’ is the connecting function between the general function ‘mean’ and the structural function ‘position’
   ‘integrate’ is the connecting function between the general function ‘mean’ and the structural function ‘merge’
   these interim functions can be used to design interface queries to fulfill solution automation workflow core interaction functions involving general functions, if they don't use specific structural core interaction functions
      example:
         a solution automation workflow like ‘find the meaning of a structure and check if it invalidates other meanings or is consistent as a way of finding possible structures to solve a problem in that system’ has an interface query involving ‘organize or integrate the structure with other structures to see if a contradiction can be created’
structural interaction functions
   the core interaction functions fulfill common structural intents, not just common to problem/solution interactions but common in general
solution automation workflow functions
   solution automation workflows are interaction structures of specific problem-solving intent functions
      a workflow may fulfill the general problem-solving intent function ‘filter solution space’
interface query functions
   interface queries are interaction structures of interaction structures to fulfill a function intent (interim functions, general problem-solving intents, solution automation workflow intents, core interaction functions, etc.)
      ‘apply the “structure interface” to fulfill the “connect” core interaction function of the solution automation workflow “connect problem/solution structures”’
      this calls the ‘build’ function (to create a ‘connection’ structure), which is fulfilled by calling the ‘apply function’ on an ‘interface’ structure
      this is an ‘embedded’ interaction structure, where one interaction structure (apply) is embedded in another (build)
   interface queries are an ‘interaction structure of interaction structures’ because they connect solution automation workflows with structural core interaction functions
      interface queries are a ‘structural implementation’ of a solution automation workflow
         All functions use the general functions (‘find’) or a sub-function of them on some interaction level, whether its an interim level between general/structure functions (organize/standardize) or structural level (‘filter’)

Example Solution Automation Function Configuration
problem-solving intent functions
   solution interaction functions
      reduce/filter solution space
         check if solution metric is fulfilled
      change standard solution
      differentiate solution from known errors
      compare solutions
      select solutions
      create a prediction function connecting inputs/outputs
   fulfill problem/solution interaction function
      calculate cost of solving problem
      remove problem/problem cause
      reduce problem/problem cause
      connect/match problem with solution
      solve different problem
general alternate info existence functions (functions that find/derive/generate info, which can be used as alternate general problem-solving intents to resolve an info problem)
   mean: organize, integrate, understand, fit
   find: filter, identify
   derive: connect, define, structure, describe
   generate: combine, specify, fill (apply ‘specificity’ to structural uncertainties, as in ‘variable values’)
   apply/change: interact
core interaction functions
   ‘find’ core interaction functions: filter, identify, select, merge (filters with possible solutions)
   ‘build’ core interaction functions: deconstruct (reduce, remove, break, separate, distribute, isolate), construct (combine, merge (structures to create a structure), group), cause (use (apply/activate/call/use/trigger), generate, guarantee/require)
   ‘apply’ core interaction functions (apply a function/structure to a structure): test, merge, change/convert, inject/embed, specify/abstract (specify a particular variant of a general type, by applying specific variable values), fill (fill a structure like a template, by applying specific values to it)
      examples:
         connect (apply a ‘connection’ structure, as in ‘fill a path’, in the template structure that is a general path definition)
         standardize (apply a ‘standard’ structure to a structure, to fill the standard definition)
         compare (apply a ‘comparison’ structure, to fulfill functions like ‘equate’ or ‘differentiate’)
   ‘mean’ core interaction functions: define (structure), fit/reference (organize/position, integrate/merge)
   ‘derive’ core interaction functions (create a certainty by resolving an uncertainty in a connection/other interaction, given a certainty, using other info than the target output certainty & other methods than info like inference/filtering/requirements)
      derive a structure from its opposites, limits/requirements, connections, definition, adjacents, attributes/functionality, inputs/outputs, vertex (descriptive/generative/determining) attributes/structures/functions
      derive missing info, using input info & alternate functions/structures than info functions, such as ‘logical implications/inference’
         derive inputs given just info about outputs
         derive variable interaction structures (like the ‘connection between independent/dependent variables’), given just data point info
         derive a missing structure given just info about the partial structure
interface operations: ‘combine interfaces’, ‘apply an interface to an interface’
interface query operations: ‘identify sub-problem’, ‘connect sub-problem output with original problem/solution, solution automation workflow, or other components of interface query’
common functions enabling interface operations: ‘apply a standard’
common functions enabling intents connecting specific functions (like interface queries or general functions or solution automation workflows) & info/structures, that should be composable with structures like combination/application/specification/variation of general functions, which are components of workflows
   find structure
      find structure with attribute
         find structure of usefulness (input/output sequence, alternate route, filter to differentiate solution/error)
      find specific structure
         find interface structure (cause/intent/structure/type)
         find error types
         find structures of cause
         find variable types & structures
   apply structure
      apply specific structure to structures
         apply interaction function to structures (create a network/sequence of structures, combine/filter/differentiate/change/integrate/organize/fit structures)
         apply a standard format (function/attribute/object) to an input
   build structure
   derive structure
   derive definition routes on various interfaces from a definition
   derive function intent stack

Example Solution Automation Attribute Configuration
attributes of specific useful structures
   attributes of solution/problem structures
   attributes of vertex variables:
      determining/descriptive/generative
   attributes of useful structures:
      abstract-structure connections
      cross-system applicability/reusability
      fulfill core interaction functions between core structures & interfaces
conceptual attributes
   interactivity
      interaction structures
         interaction functions (core, general, standard)
         interaction level where interactions of a scale/type/other attribute occur
         interface
         primary interfaces (function interaction level, variable interaction level
         specific attributes/structures on interfaces
         input/output interaction level
         time interaction level
         abstraction-specification mix
         cross-interface mix of some specific structures & some abstract structures
         attribute mix
         mix of consistency, randomness, balance, etc.
         interface structure mix
         mix of priority, problem, type, structures, intents, etc.
         interaction space (of all possible interactions of specific structures)
         interactions not designed with intent, such as a function: errors, complexities, emergent structures, variance (source of potential/uncertainty), randomness (random collisions, coincidences)
   certainty
      certainty from survival (continued existence): commonness/patterns, cooperation/connectivity, reliability, consistency, stability
      certainty from enforcement: inevitabilities, requirements, possibilities/probabilities
      uncertainty (opposite of certainty): ambiguities, coincidences, randomness

Example Solution Automation Structure Configuration
primary interface structures (and useful or default structures defined for primary interface interactions on those interfaces)
   core: default (unit, object, attribute, function, type)
   cause: structure (dependencies, inputs), potential (probabilities, certainties like inevitabilities, requirements), concept (power, connectivity/interactivity, randomness), function (generative/activating functions), info (problems)
   concept: default (abstract cross-system concepts like power, balance, positive, interactivity, certainty, stability, meaning)
   change: default (variable), math (distance, adjacence), structure (difference, alternatives, substitutes, interchangeables)
   potential: default (probability, possibility), concept (variance as a source of potential & uncertainty)
   intent: meaning (priorities, usage), structure (direction)
   info: errors (types, cause), solutions (identifiers, requirements, cause), questions, answers
   pattern: structure (abstract pattern versions)
   function: variable (config, inputs/outputs, description/generative/activating/causative/determining, assumption/requirement/usage variables), structures (input-output sequences, sources, origin), logic (logic sequences/networks/trees)
   structure: interactions (intersections, combinations, merges, collisions), default (limits/boundaries, filters, position), comparisons (differences/opposites, equivalents/similarities/alignments, alternates/interchangeables)
   logic: contradictions, assumptions, implications, conclusions, consistencies, validities
   system: requirements, efficiencies, benefits/costs, conflicts, standards, bases, defaults, meaning (context), structure (boundaries, connections), logic (consistencies)
   math: change (difference, symmetries)
   meaning: structure (definition/reference, integration, organization, fit), concept (understanding)
core interaction structures: combination, network, sequence, tree, set
structures of structures
   structures of attributes
      usefulness
         core useful interface structures
         math value reference structures (extremes/minimums/maximums/averages/symmetries)
         change structures (variables)
         structure structures (subsets, combinations, bases)
         useful attributes
         reusability: can be used as inputs to many other functions
         successful: fulfills solution metric such as ‘reaches destination node’
         useful structures of interface structures
         useful attribute+useful core interface structure
         interchangeable alternatives
         maximally different inputs
         type/phase change boundaries
      useful attribute structures
         organization, certainty, interactivity, learning, relevance
         example with ‘optimization’ attribute structures:
         apply optimization/usefulness structures to components that should be optimized (data, learning function, input/output connection)
   structures of functions: reduce, embed, connect function structures (the general “apply ‘connection’ structures to connect structures”, or the specific “apply ‘input-output sequence’ structures to connect structures”, since input-output sequences are a connection structure)
   useful structures of structures
      useful structures of workflow variables
         requirements: requirements of workflow variables
         efficiencies: workflow variables that make a task trivial (commonly useful workflows/functions)
         ambiguities: the ambiguity present in variables like core interaction functions mean that any of the functions can be selected for a given workflow/interaction
         related object network position (workflow fit)
         generative structures
         vertex variables
         alternate workflow versions
      useful interface structures of interaction structures of workflow variables
         useful intents of structural interactions (connect, optimize) & interactions of workflow variables where they would be useful
         ‘connect’ useful for ‘equating’ which is useful for ‘equating a problem/solution’
   interaction structures/functions of structures
      interaction structures/functions of workflow variables
         ‘reduced’ combination′ of ‘connections’ between ‘solution automation workflows’ (reduced to unique values)
         ‘reduced’ combination′ of ‘patterns’ between ‘solution automation workflows’ (reduced to unique values)
   interface structures of structures
      interface structures of interface structures & interaction structures
         default combination: ‘core’ cause′ structures
         embedded interface applied to default combination: ‘intent’ of ‘core’ cause′ structures
         connection between interfaces: common interaction structures like general function structure of ‘merge’ across interfaces ‘meaning’ & ‘structure’
   structures of interface structures: structures of cause/potential/meaning

Example Solution automation workflow variables/attributes
related object network position (workflow fit)
generative structures
   function to generate the workflow
   solution success/failure cause
vertex variables of solution automation workflows
   interface queries implementing the workflow
      interface queries act as a ‘problem-solving function’ or a ‘solution finding/building/deriving function’
      example: many queries can implement the ‘trial & error’ workflow, bc some implementations will try certain combinations before other implementations, even when using the same combination-generating function in the same language there may still be variation in the implementation
   interface structures applied
   interaction level (general abstraction layer or type of functions/structures applied)
   core problem-solution interaction functions (reduce, connect)
   general functions applied (find, apply, build, derive)
   problem-solving intent functions fulfilled in the workflow (filter/compare solutions, solve different problem, connect problem/solution, reduce problem/problem cause)
   useful structures
   problem/solution structures applied in the workflow
   solution/error success/failure case
   useful structures applied to problem/solution structures
      structures of certainty applied to create info
      structures of optimization applied to improve solutions
      alternate problem input/solution output routes
alternate workflow versions
   generalization/abstraction
   simplification/compression

Example Solution Automation workflows

What follows are additional examples of solution automation workflows. These workflows involve interface structures like ‘cause’, functions types like ‘generative functions’ & useful structures like ‘alternatives’ & ‘errors’.

Identify difference-reducing/generating structures of various successful interface queries for the same problem and identify their inputs so they can be generated
workflow fit: this is similar to the ‘find differences between useful structures so they can be generated’ workflow but is specifically applied to interchangeable interface queries, which are interchangeable bc of their similarity in success probability
generalization: this can be generalized to ‘find differences between useful structures like alternates/interchangeables so they can be generated from each other, and apply this generative function where these structures are most useful (alternate interface queries are useful in generating alternative interface queries)’

Identify structures like functions that lead to different useful perspectives to handle errors beyond standard solutions' error-handling capacity
example: ‘identify opposite structures, then identify middle/interim structures between original/opposite structures’
this is how to get out of mental dead-ends, and is also a useful structure for generating new structures like new variables
this is useful in cases like the ‘find a prediction function’ problem, where static standard solutions like regression or machine-learning may be just good enough that they take over as the only solution to focus on, and prevent alternate perspectives that may be useful from being considered, which would reduce errors further
generalization: ‘find perspectives that produce solutions & how to generate those perspectives’
example:
   regression: the perspective of ‘the average function is the best predictor’ is the perspective that made regression adjacent/trivial to identify
   machine-learning: the perspective of ‘trying various variable combinations, updating them according to what works, & disabling what combinations don't work’ is the perspective that generated machine-learning
   interface analysis: the perspective of ‘finding differences easily’ or ‘reducing complexity quickly’ or other related problem-solving interim intents are perspectives that could generate interface analysis
   solution automation: the perspective of ‘finding solution outputs from problem inputs’ is a perspective that can generate solution automation
some of these perspectives offer more trivialization of the solution identification than others
the differences between these perspectives have rules/inputs that can automate the process of finding useful perspectives to make solving a problem trivial
workflow fit: this is similar to the ‘find solution automation workflow that can solve all problems’ problem-solving intent, specifically for solving the problem of ‘finding alternate useful perspectives to find alternate solutions that can reduce errors beyond standard solutions’, which is related to solving all problems

Identify useful structure causes (why is something useful) and apply causes as generative functions
example causes of usefulness:
   adjacent/available/common/core
   its an input to a useful structure
   its powerful (like a ‘vertex’ variable)
   it increases/decreases some optimization/sub-optimization metric like ‘understanding’, ‘simplicity’, ‘efficiency’ (‘organizes’ or ‘decomposes’ sub-optimal structures like ‘complex’ or ‘noisy’ structures)
also apply other interfaces structures to create other useful structures that can fulfill an intent like ‘generate useful structures’:
   apply ‘patterns’ of useful structures to generate useful structures
   apply ‘patterns’ of ‘causes’ of useful structures to generate useful structures
   apply ‘inputs’ of ‘patterns’ of ‘causes’ of useful structures to generate useful structures
generalization: this can be generalized to generate ‘useful structures’ (like ‘input output sequences’) of useful structures that can generate useful structures, to fulfill problem-solving intents, which can be related to useful structures like ‘generate useful structures’
workflow fit: this is similar to the ‘apply useful structures or variables of useful structures to generate useful structures’ workflow, with an abstraction layer around it that can be applied to fulfill problem-solving intents in general since useful structures are an input to problem-solving intents in general

Identify cross-interface structures that are useful as useful structures (like input structures like starting points/components/triggers or output structures) of problem/solution structures
example: a particular workflow state/variable/variable value might be more useful than another
   this is a combination of various interface structures (‘state’, ‘input variable’, ‘variable value’) that differs from a standard perspective of just ‘applying variables’
   other useful interface structures than state/variable/value may exist that are useful to apply as a default configuration of a particular problem/solution structure
workflow fit: this is similar to the ‘find useful cross-interface structures as useful structures such as connecting structures of interfaces or default interaction structures’ workflow, but applied to general problem/solution structures like workflows, rather than specific problem/solution structures like prediction functions/variables

Identify other workflow variables/inputs/components & applying differences & other useful structures to find useful alternate versions or alternatives that fulfill useful structures (like ‘optimization’ structures)
example:
   identify ‘emergent structures’:
      a combination of workflow variables/values/states might produce a structure that reveals both of the combination inputs, so the structure produced is an alternate workflow variable/value/state that can be used in place of the original, which is more optimal than finding the original structures used in the combination
workflow fit: this is a variant of the ‘apply interface structures to find other problem/solution structure variables’ workflow, specifically to fulfill useful structures like optimizations

Find the interface-associated functions where functionality gathers (like find/apply) and connect them to interface functions on other interaction layers core interaction functions (connect/reduce), interim cross-interface interaction functions (‘find a structure in a structure’) and problem-solving intents (‘filter a solution space’), to have default function connections to use as solution structures
interface-associated functions include (find/apply/derive/build/mean) which correspond to various primary interface (info/change/logic/core/meaning)
   these interface-associated functions can be the primary interface functions or specific interface functions in a specific problem space
   these functions are associated with functions on other interaction layers that are more adjacently connected
generalization:
   this can be generalized to other interface structures than functions
   rather than creating connection structures (function structure providing inherent ‘connections’), you can create direction structures using the intent interface structures, or cause interface structures which also have direction but are more associated with inputs/triggers as a default structure
      find interface-associated ‘intents’ to find primary/specific ‘direction’ structures
      find interface-associated ‘causes’ to find primary/specific ‘trigger/input’ structures (like requirements, inevitabilities)
workflow fit:
   this involves a way to generate/find/derive the important/useful structures, rather than applying a search filter or definition

Apply optimization structures to find useful interface-associated functions & other useful interface-associated structures on other interfaces
‘reduce’ is an optimization structure for various intents like ‘finding unique causes’, ‘isolating objects’, ‘determining/describing/predicting’
   ‘most reduced’ functions can mean:
      core/component functions
      functions covering the most functionality
      most general functions
      most interactive functions
      functions most adjacent to the most functionality
generalization:
   this can be generalized to other interfaces
workflow fit: this is a specific version of ‘apply useful structures to find useful structures’ applied to specifically find useful structures with the primary interface structures, given that they're by default the most useful structures

Create structures of error structures to identify contexts where a solution would be wrong (like ‘if a data set is an outlier data set’), optionally selecting the contexts where the most possible solutions would be wrong or the most different contexts or the most costly errors to reduce the contexts to rule out, and rule out those contexts to find solutions that are likelier to be successful
the filters of contexts where a solution could be wrong can be used in general as solution space filters, to apply as various definitions of cost
   reduce any costs:
      most possibilities
         the most errors that can be handled, meaning identifying/correcting as many as possible to apply an equal priority to all errors
         all errors should be handled if possible, as every error is treated as something that needs to be corrected
   reduce most common costs:
      most common possibilities
         most similar to other error values, meaning this is a common error
         so it deserves higher priority be common errors are assumed to be a problem that requires fixing for the system to work
   reduce most different costs
   most different possibilities
      most different from other error values, meaning ‘this is a special error’
      so it deserves higher priority bc that implies its a source of variance & therefore future different errors
   most wrong possibilities
      most different from correct value, meaning this is an extreme error
      extreme errors are assumed to be the highest priority bc a huge difference in one position could create huge differences in other positions unless there's a difference-handler like a distribution function or if the position doesn't connect with many other components (like a print statement, which does interact with available memory/processing power but is unlikely to cause error structures if it fails on its own in isolation)
   various structural definition routes of an outlier include: ‘a set of extreme(s) that is not incorrect according to some group definition of correct’, or ‘requires a different prediction function version or different variables to predict’, or ‘indicates an early signal of impending/preceding group change’
   ‘identifying a representative data set as an error (outlier) or vice versa’ is wrong in some of those definitions (where its a legit member of the group), which can be ‘assumptions’ in the ‘contexts’ in this workflow
   to apply this workflow to the problem of ‘find a representative data set’, the program would:
   identify in which contexts a particular solution function would ‘incorrectly identify an outlier data set as a representative data set’, and rule out those contexts as not applicable to the problem space
      “in this problem space, none of those contexts apply, so the solution function to ‘identify a representative data set’ is probably successful”

Identify interactive structures that form useful structures that can connect to problem/solution structures
example: for an ‘input-output sequence’, interactive structures include:
   alternative structures/formats like a ‘function’, which connect to problem-solving intent functions, interim functions, general functions, or core problem/solution interaction functions
   triggering structures like ‘requirement for an input-output sequence’, which connect to ‘solution metric requirements’
   difference structures like ‘output-input sequence’, ‘input-output set’, ‘logic sequences’, which connect to different solution automation workflows (like how a reversal connects to a ‘reverse-engineering’ or other ‘derivation’ workflow)
some of these interactions form structures like a ‘complete object’ (‘complementary’ structures like halves forming a circle), others form ‘connection’ structures' linking a problem/solution structure with another structure or sets of functions
   these formed structures are useful for problem-solving intents & workflows for various reasons (some are default/core/component structures, some connect useful structures with useful intents, etc.)

Add useful functions as components that are alternatives to useful structures as components/inputs/triggers of problem-solving structures
functions are classifiable as structures, but some structures are more clearly identifiable as structures by default, and functions are specific & complex enough to differentiate
useful functions are often combinations of general function intents, structures, problem-solving intents, and therefore offer a useful integration structure of these problem-solving structures
examples of useful functions:
   ‘find structure of an interface structure in another structure’
   ‘test (check, simulate) if a change is consistent in a system defined by these rules’
generalization: this can be generalized to other default structures of interfaces, so that the interaction layers of problem-solving structures (general functions, problem-solving intents, interface queries, core interaction functions, solution metrics, useful structures, workflows) can be integrated
example:
   functions/input-output sequences being a default structure of the ‘function’ interface
   differences between object states being a default structure of the ‘change’ interface
   directions being a default structure of the ‘intent’ interface

Identify useful structures automatically given their common attributes & their definition & apply as inputs to other problem/solution structures
example of attributes to identify useful structures automatically
   produce useful info
      a trade-off is useful bc any change to it can produce info about a particular error type (‘which priority is sacrificed when another priority is promoted’), and error structures are by definition a useful structure relevant to problem-solving
   useful as inputs that enable other structures
      core structures are useful bc they're common inputs/components of other structures
   interactivity/connectivity
      hub structures are useful bc interaction/connection structures in general are useful
   synchronization
      repeated/common structures (like patterns) are useful bc what generates one example of a pattern is likely to influence another example of a pattern
   in general useful structures will be structures of useful attributes like optimization/certainty structures, implementations of or inputs to core interaction functions, or capture & create relevant info out of high-variation info

Identify structures of useful structures that are useful for specific problem-solving intents or problem/solution core interaction functions & apply those specific structures of useful structures as an initial solution set (or solution component/input set) to solve the problem of ‘designing the interface query’
example: structures like ‘sequences’ of useful structures like ‘requirements, alternatives, interchangeables, equivalents’ are useful for core interaction functions like ‘connect’ or problem-solving intents like ‘connect problem/solution’

Apply useful structures to each other (like error-neutralizing structures & interaction structures) in a useful structure (like an input-output sequence or integration structure) to generate probably successful solution structures
example:
   the ‘balance of power’ structures present in some government structures has a default ‘error-correcting’ structure built-in, to prevent any one component from becoming too powerful (avoiding the error structure of ‘centralized power’)
   interaction structures (like input-output sequences) are useful on their own to reduce the solution space, and connecting them to the problem/solution is a good workflow
      this workflow can be improved by adding error-neutralizing (optimization) structures & other useful structures, in a way that allows them to be validly connected (in a way such as an input-output sequence or merged/integrated structure)

Apply structures of useful structures and derive their interaction rules to generate a solution automation workflow to guide the interface queries that can optimally be executed on these structures
example:
   useful structures like cost/benefit, input-output sequence, supply/demand, power/complexity/balance are alternate structures that capture a high ratio of variation
   some interaction rules come with these useful structures, whether definitively/implicitly
   cost/benefit analysis comes with the implied rule:
      ‘identify the cost & benefit of a move and check if the benefit is greater than the cost’
   the interaction of these useful structures would also have interaction rules, between the structures & their defined/implied structures
   for an interface query analyzing the power & cost/benefit of a structure to determine useful structures or solution solutions or solutions, the interactions of power & cost/benefit structures would need to be derived to guide the interface query design
      an example interaction rule would be:
         ‘identify the structures with power in the problem system & assign them as benefits & assign responsibilities associated with power as costs, to find solutions that maximize the benefit/cost ratio’
      this rule applies the rules implied by the cost/benefit structure and the definition of power, in a way that fulfills the ‘connect a problem/solution’ problem-solving intent
      this rule is not specific to the problem, but is a workflow acting as a guide for the interface query applying these structures to ‘connect a problem/solution’ (a problem-solving intent of various solution automation workflows)
   workflow fit: this process is applied specifically to structures that are useful for capturing a high ratio of variation, and applies solution automation workflows to integrate them with problem/solution structures to filter out less optimal interface queries implementing the workflow generated from these interaction rules

Apply the cause of (reasons for) variable interactions to derive alternate probable structures of variable interactions to filter the solution space & integrate as valid alternates until any are ruled out by additional info or interface applications
example:
   for the ‘find a prediction function’ problem, there may be multiple reasons why the variables would interact in the patterns reflected in the data
      some of these reasons would involve ‘false correlations’, ‘missing variables’, and other common variable interactions
      alternate prediction functions based on these reasons for variable interactions can be used as conditional functions (called conditionally based on probability of those reasons being relevant for a given input)
      additional interface applications can be used to filter these alternate prediction functions further, like:
      applying the ‘change’ interface to find out if these alternate functions are essentially interchangeable, or if they can functions as bases of each other, or have other function interaction structures
      applying the ‘pattern’ interface to filter for more probable variable interaction structures

Derive the info that is capable of producing the info of the solution & find that info
example:
   for the ‘find a prediction function’ problem, info that can produce the ‘prediction function’ includes info like ‘similarities between independent/dependent variables’ and ‘conversion functions to create similarities’
   once you know what info is required to produce (of capable of producing) the solution, the interface query can be designed to produce that info
      example of an interface query subset:
         ‘find similarities between independent/dependent variables’
         ‘find methods to identify similarities between values’
         ‘find methods to identify patterns of similarities between values’
         ‘find methods to identify equivalents/differences between values’

Find the symmetries in a problem system based on which components are interchangeable & identify the interaction level where they exist & the symmetry they're based on, then find a conversion function to connect those symmetries to understand a problem system quickly
understanding allows identification of required components to optimize the system & alternate interaction methods between components
example:
   in the ‘find a prediction function’ problem, symmetries exist around an ‘average’ function, between ‘base’ functions, between prediction function requirements/limits & the prediction function, between function patterns & the prediction function, between variable interaction patterns & the prediction function, between data & the prediction function, between ‘subset’ functions & the ‘composite’ function
   these symmetries provide alternate ways to find the prediction function, with alternate adjacent operations connecting objects formed by changes in each symmetry

Identify required structures necessary for a solution to be adjacently optimizable, such as a ‘contradiction’ structure in the form of an ‘opposite solution’ to identify when a solution is nearer to its opposite structure (‘not a solution’, as in an ‘error’), and build those structures instead of the original problem's solution structures, then apply optimization structures once its in an adjacently optimizable state

Identify structures required to identify useful structures (solutions, optimizations) in every structure of structures (combination/group/mix/sequence of structures) in any system & apply as default/core/component/interaction/input/reference structures or other useful problem-solving structures
example of structures that can identify optimal structures in many cases on their own:
   ‘sets having just a few attributes like consistency & stability’
   useful structures like ‘alignments between change types’
   ‘priority combinations that create consistency or other optimization structures’ in a system
   an example of a way to apply this is identifying whether a solution is moving toward useful structures standardized to that system or away from them
   this means finding the structures of ‘consistency’ & other useful structures in a system and identifying whether a solution is more similar or less similar to that structure as its changed, as a way to find optimal solutions in that system

Identify change causes (like benefits/costs) and apply change functions to those change causes (like applying ‘distribute’ to ‘benefits’ to ‘change their position’) & check if a solution is produced by the changes, bc if the original problem system produced an error, a probable cause is that the rewards/punishments/other change causes were in incorrect positions/amounts/structures
generalization: find other ‘probable causes of error/solution structures’ that can act in place of ‘known error/solution causes’, as well as other variations of important attributes like solution success cause such as solution/error inputs/defaults/variables/requirements, including:
   patterns/approximations of error/solution structures
alternate generalization: find other functions that when applied to other structures, can produce solutions
   in general, this solution automation workflow is based on the insight that an ‘error is a difference from a solution’, but there are many ways to apply that insight to generate workflows involving identifying/correcting errors or generating solutions from them
related workflow: a related workflow is ‘apply changes to see what you can convert a structure into, bc if its adjacently convertible into an item, its similar to that other item in some way, as a method of generating an identification function (“identify” being a core problem/solution interaction function)

Identify other structures like bases (such as errors, standards, differences) that a solution or other useful structure can use as a reference like a limit to define itself & apply those to generate the solution/useful structure

Identify different interaction structures of structures that are particularly useful & apply them as default/core/component/interaction/input/reference structures or other useful problem-solving structures
an example interaction structure is an ‘overlap of different structures of usefulness’, like an overlap of optimizations/cooperation/stability/certainty/consistency structures
a structure that can act like many other structures (abstractions, structures of commonness/reusability, base structures)

Identify structures of success (cooperation/consistency/stability) & other useful structures (like overlap structures) between useful structures (like overlaps between optimization structures & structures of certainty), which are more useful than structures of any one type of usefulness on its own & apply them as default/core/component/interaction/input/reference structures or other useful problem-solving structures
a ‘consistent system where different change types interact in way that allows them to coexist’ is likelier to survive & be stable

Identify the reasons that a structure might be misidentified as an error by another structure, and apply as contradiction/opposite structures to optimize an error identification function that can automate finding/generating/deriving solutions by identifying what is not an error
reasons like:
   ‘its not similar to previous success/solution structures, like a previously successful priority’
   ‘its not similar to our structures’
example:
   a small group might be misidentified as an error by a large group, even though all necessary changes/improvements might start at a unit size
this is an example of bias (an incorrect constant rule/function) that comes from rewarding itself & its own perspective, without acknowledging the possibility of another path to success

Apply error structures as components/inputs/other useful structures of solutions, either as filters of solutions, adjacent states to solutions that can be inputs to approximation structures (‘partially/almost correct’, as opposed to ‘irrelevant’), or alternate states of solutions that are conditionally correct in a different context

Apply useful structures (like solution success causes, useful structure filters, generative functions, patterns of alternate routes) to find/derive/generate useful structures, apply them to generate/find/derive useful structures, and apply those useful structures to fulfill problem-solving intents

Apply useful structures like ‘similarities’ to fulfill core interaction functions like ‘connect’ for relevant problem/solution structures like ‘problem inputs & solution outputs’
example: a ‘complex’ system has structures that can function adjacently as ‘inputs’ to ‘complexity’, like ‘multiple alternatives/options’, ‘multiple variables/differences’, ‘contradictions’, ‘conditions’, ‘conflicts’
   there are ‘similarities’ between these structures and structures of complexity, so ‘similarities’ can be used to fulfill common problem-solving sub-intents like ‘generate outputs from an input’ or ‘identify inputs of an output’
   ‘similarities’ are also useful for core interaction functions of problem-solving like ‘connect’ be they reduce the work required to connect different structures
this can be generalized to other useful structures that adjacently fulfill core interaction functions (like connect) between relevant problem/solution structures

Apply useful interface structures like the physics/info interface to filter out possible info or other interface structures that can be used to find/build/derive solutions
only some info is possible given how physics works (specifically how energy can stabilize into structure), and only some info interactions are possible (such as how charged particles can interact like ‘neutralizing each other’ or ‘repelling/attracting each other’)
these physics rules can apply to info interactions, like calculating the certainties generatable with inputs/functions (determining what info can be produced with other info)
example: can a boolean variable with this distribution determine a type variable with this distribution, with x available functions & a limit of n function calls?
this can be generalized to other interface structures like combinations/applications of interfaces that have functions useful for fulfilling connection/filtering/reducing or other interaction functions
   physics is a particularly powerful interface impacting all the others, and the info interface has ‘certainty’ structures defined on it by default, so thats why a combination of these interfaces is useful for finding functions connecting certainty structures that can be used to filter possible connections in a problem space
the generalization of this is ‘find the interface structure of interfaces that can determine specific useful structures (like “interaction rules of certainty structures”) that can be used to solve a particular problem, given the definition of these interfaces which includes their core structures & which interface structures of interfaces would make finding interactions between those structures adjacent/trivial, and apply these to fulfill core interaction functions between problem/solution structures
only some interface structures can adjacently determine the useful structures that can solve any problem (like certainty structures or difference structures), which is why this is different from generally applying interface analysis—this is specifically applying it to find interaction functions between these useful structures that can be plugged in as inputs to core interaction functions to fulfill problem-solving intents
this is a similar operation to ‘finding a different interaction layer/structure that highlights a particular interaction’ (as opposed to just ‘finding a space where a difference is maximized’)

Find patterns/functions connecting generally useful (such as ‘reusable’ as in ‘cross-interface’) input/output & core interaction function (like ‘connection’) structures (like ‘certainty structures’) & apply them as filters of possible interaction & output solution structures for an input problem (or input structures for a given interaction & output structures, etc.)
example: some inputs & functions can only produce output certainty structures with a particular attribute (number, type), and these interactions can be used to determine which inputs/connecting functions can be used to produce a given solution output, providing a filter of possible solution-generating functions

Identify attributes of a problem that indicate a particular solution automation workflow is optimal for that problem, and find base problems with different optimal solution automation workflows, and use these base problems to determine how different an original problem is from the nearest base problem, and apply differences to that base problem's solution to find a solution to the original problem quickly
the only problem space where you would need to apply ‘trial & error’ is where the outputs are perfectly random (so only when trying to solve the problem of ‘find all the values in a perfectly random sequence’)
every other problem has useful structures (such as patterns) that allow the problem to be solved more efficiently
solutions can be designed by applying differences to the solutions of this problem where the solution of ‘trial & error’ is required, differences in solutions that match the differences in problem structures
example:
   if a particular random function has known error structures making it non-random, those error structures can be used to reduce the sections of the sequence that are considered actually random, thus reducing the number of values that need to be checked with ‘trial & error’ (if an error structure in a particular random function is an occasional non-random sequence with identifiable attributes, those sequences can be checked for & their bounds can be checked, invalidating the need to check every value in the error sequence section, reducing the total number of operations)
      so the ‘non-random error structures’ can be used to reduce the search/solution space of ‘random sequences to apply trial & error to’
      this solution requires a structure (like a function) to handle ‘finding the error structures & removing them from the search/solution space’
      this matches the difference in the problem space (meaning “an occasional ‘non-random error structure’ in the sequence”) with a corresponding difference in the solution (a ‘function to differentiate these error structures from random sequences to reduce overall value checks’), fulfilling the solution metric of ‘a solution with fewer than n operations (such as value checks), n being the size of the sequence’
      there are many ways to fulfill this solution metric, with:
         varying trade-offs of other solution metrics like accuracy, depending on the method used to fulfill the solution metric
         varying applicability, in terms of which methods are useful, given a particular input or problem space (like a known error in an imperfect randomness function)
      methods of fulfilling this metric include:
         finding patterns in the sequence (such as sub-sequences of length k that have a relatively even distribution of possible values) approximating/predicting answers rather than checking them, based on which sub-sequences of length k would have an even distribution of possible values
         identifying sub-sequences indicating randomness/non-randomness & their probability of occurring with frequency x in a random sequence, and reducing the search/solution space by identifying these sequences & applying their bounds to avoid checking every value (whats the likelihood of ‘111111’ vs. ‘111151’ in a random sequence with a particular random function implementation, and to what extent does each value need to be checked to assume its one sequence vs. the other)
         applying the same method, but applying it only to a subset of values (checking some values & predicting others)
      finding error structures in the random function & applying error structures to reduce the solution space
      feeding the sequence into a function that requires a random sequence to avoid replication of work, and which produces some structure of certainty like a processing halt or error response when it finds a non-random sequence
      replacing with a generated random sequence, since the problem definition only requires that values in a random sequence be identified, and if a sequence is really random, it wont matter which random sequence is used
      mapping common/all/probable/average random sequence patterns and once a sequence is identified as belonging to a certain type or group of random sequence patterns, apply a conversion/generative function between the sequences in that type/group to tell which sequence it is likeliest to be, without checking all the values
      similarly, organizing a space of random sub-sequences where adjacence is determined by probability of occurring in the sequence at all, or next/previously in the sequence, and checking endpoint values rather than every value, to see if a continuous path in the space can be traversed

Identify & apply patterns of a particular problem space's variables (like ‘input context’, ‘solution-finding method params’, ‘variable interaction structures’, ‘problem/solution structures’) as inputs to data/function optimizations
example:
   apply patterns of differences between network params & interface structures like variable interactions (such as ‘adjacent features’) & variable types (like ‘type’ variables) it can identify, to generate the right network params to identify the maximum number of relevant structures & not identify irrelevant structures
   apply patterns of differences between worst/best/average/other/outlier/alternate/noise/error case contexts to identify if a data set is a ‘worst case’ or ‘average case’ or ‘best case’ context, to generate the right differences to identify other cases to weight it against
   apply patterns of differences between an original problem & a useful system to apply rules/structures from to find relevant useful systems to apply rules/structures from to solve the original problem

Apply specific examples of other specific but generalizable problem formats with known solution methods having useful connection structures to the original problem, like similar inputs/outputs or similar problem-solving intents like ‘reduce’ (such as ‘find a prediction function’, ‘find a sort algorithm of a sequence to find a particular value quickly’), to apply as sources of solution formats & methods for the original problem, converting the specific problem/solution format to the original problem & applying solution methods from the specific problem to solve the original problem once converted to specific problem structures
example: ‘sorting algorithms’ applied to the ‘find a prediction function’ problem could take the form of ‘starting the search in the middle’ which would take the form of the ‘average/regression line of the data set’ or ‘applying two sorts in parallel starting from different positions’ which would take the form of ‘alternate prediction functions from maximally different bases or standard functions’ when converted back to the original problem
these specific problems have solutions that are generalizable to other systems
   ‘sorting’ structures can be used in place of ‘filter/test’ structures bc they have similar inputs/outputs
   just like an ‘average’ structure or a ‘dimension-reducing’ or ‘feature-selecting’ method can ‘reduce’ the problem of ‘find a prediction function’
the generalization of this is ‘find the interface structures that are relevant to solving problems & connect them to problem-solving structures’, with examples like:
   ‘specific function’ (‘abstract’ variable as ‘specificity’ applied to ‘function’ interface structure), which is useful for solution workflows involving ‘finding specific functions that all problems can be converted to’
   ‘function cause’ (or ‘function inputs’, like ‘function requirements/assumptions/variables/triggers’), which is useful for solution workflows involving ‘finding a generative function of a function to identify & solve problem cause’
   these structures are particularly useful for solving problems bc they involve inherently useful interface structures (functions) which is a format all problems can be converted to, and apply useful attributes to those useful objects (like ‘cause’ or ‘abstraction’) to identify other useful structures that would be useful for solving problems, given that a function is already known to be a useful structure for solving problems

Identify patterns in limits on what info a function can find/derive/generate & apply those to rule out possible solution-finding functions to filter other functions that shouldn't be applied, or apply differences to those limited functions to find functions that can find/derive/generate the info

A generalization of my invention is ‘abstracting a problem/solution in a structural way’, thereby connecting the ‘abstract’ & ‘structure’ interfaces, the abstract interface being useful for identifying types, concepts, patterns & meaning, and the structure interface useful for identifying connections/similarities/differences, so their link is useful for finding connections/similarities/differences between definitions, types, meaning & other abstract structures
other interface structures combining/integrating other interfaces to each other are useful for other problem-solving intents, but this is a particularly useful structure (specifically a ‘connection’ structure) of interfaces
the reason why interfaces are useful is bc having the attribute of ‘flexibility’ in the form of ‘multiple alternate formats’ of info (multiple ways to format the same input info) that don't lose relevant information like interactions, makes it possible to use different functions and compare them more easily to other structures that another structure may already be in, making some comparisons (or other adjacent useful core operations) more trivial than others
interfaces can be formatted as a symmetry, filter, or standard depending on the interface applied to its definition

generalize your method of finding a specific useful structure (like lattice multiplication uses) to find a solution to a specific problem (like the multiplication problem), rather than relying on standard useful interface structures to easily compare/connect/reduce/organize problem/solution structures
how would you find a specific useful structure to solve a specific problem, such as the structure used in lattice multiplication or a tensor (matrix of matrices) used to solve the problem of ‘determining differences between objects’?
   find a structure that makes the required info obvious (structural)
      a structure that makes the required info structural is one in which the required info would have an obvious structure (a shape, area, position, difference, etc.) that is different from other structures possible in that space
         a tensor is useful for finding equal/different matrixes bc it involves creating the different configurations of the matrix, which allows them to be easily compared, once the various different matrixes are standardized to the same format (matrix)
         other structures like the inverse/diagonal of a matrix are included in this structure, but those structures aren't the core structures aligned/differentiated/comparable by this format
         the lattice is useful in multiplication bc it aligns relevant numbers by position (the ‘digit’ math structure), standardizing their position & allowing combination of similarly or equivalently positioned values
         there is other info in this structure (like pairs of adjacent numbers), but the individual digit positions themselves are aligned, making each position's differences in value comparable, rather than making other numerical structures comparable
      the common factor is that the standardization reduces other differences to allow the important difference to be obvious, where a similarity (like digit position or matrix row/column numbers) acts as a symmetry where the differences (in digit position value or row/column value) can be easily compared
      so finding a structure useful for solving a problem like ‘compare to find useful structures like differences/equivalences’ can be reduced to ‘find similarities that can act as symmetries in the problem/space, on which the important difference will be structural, & clearly different from other difference types’
      ‘finding differences/equivalences’ is a structural problem-solving intent common to many solution automation workflows, and is only a sub-intent of the example problems given above, but this same method can be applied to find other specific useful structures to solve other specific problems
      this specific method of ‘find a similarity that can act as a symmetry (sub-interface)’ as a solution to the problem of ‘finding equivalences/differences’ can be generalized to other useful structures than symmetries (like ‘filters’) but how would you match a ‘symmetry’ with a ‘find equivalence/difference’ problem, as a particularly useful structure?
      the functions possible with a ‘symmetry’ (‘find inputs that create changes’ and ‘find inputs that don't create changes’) can connect the ‘find equivalence/difference’ problem input with a solution output (equivalences/differences), given the definition of equivalence (lack of change) & difference (change) standardized to the change interface (the ‘change’ definition route of an equivalence/difference)
      so this workflow should include a step to ‘find the important useful structures, using useful interface structures like definitions, inputs/outputs, & differences to final solution format to determine relevance/usefulness of structures’ that can be an input to the function ‘solving the specific problem’ that make the problem-solving function's logic trivial to structure or finalize (finding a function to ‘connect a symmetry and an equivalence’ is more trivial than ‘connect the original problem system to an equivalence’)

Find/build/derive a relevant comparable system where the answers are more clearly determined and apply rules from that system to the original problem system, finding comparable systems by which attributes are relevant, as associated with useful/determining/identifying (constant after application of various change types) attributes that the original problem system & other systems have in common (a similarity in their interaction types/structures)
this could be constructed (bottom-up) (build) by identifying important attributes & combining structures having those attributes in a way that doesn't invalidate the attributes (to simplify/generalize the important process so it can be measured more clearly & more easily determined to be useful to inject in the problem system in a particular position/structure) or by querying known systems (find), or derived by applying requirements of the system as filters of possible useful system structures/components/variables to fulfill the requirement intents (top-down)
example: if you noticed that a particularly important sub-connection in the problem system seemed to be that ‘current position & a random function are inputs to the next position’, you could find/build/derive the Markov chain model from this connection & apply that to verify that connection's structure
how would you identify your initial theory to verify, linking ‘current/next position’ in the first place—by applying common/core/other interface structures to determine possible/probable functions in the problem system, random being a core conceptual structure on the math interface, and the ‘adjacent connection’ between the 1-degree of change linking current/next position in the ‘position sequence’ or ‘state sequence’ being a ‘core useful structure’ on the ‘system interface’ as well as ‘a unit structure of change’ on the ‘change interface’
once you have possible/probable connections, they can be tested by finding/building/deriving a system to verify them as mentioned above (fulfilling a core ‘check/test’ intent or the ‘filter’ intent), which helps with the ‘find a prediction function’ problem, solution-generating methods to which can be used to solve other problems—so this is primarily useful as a way to filter solutions to the ‘find a prediction function’ problem, to create prediction functions to solve general problem-solving intents like ‘filter solutions’ or sub-problems (like ‘sub-queries of an interface query’)
this can be generalized to apply to other problems which, when a solution-finding method is found for those problems, the solution-finding method can be used to solve most/all other problems, bc the problem is a format that other problems can be standardized to
general structures like ‘connect problem/solution’ or ‘reduce problem’ or ‘break problem into sub-problems & merge sub-solutions’ are general workflows that offer structures that other problems can be standardized to
however, some specific problems can also be useful formats that other problems can be standardized to, bc of the definition/relevance of their related components, like the ‘find a prediction function’ problem
given the definition of a ‘prediction’, the solution-finding methods of the ‘find a prediction function’ problem are inherently useful to solving other problems, as an alternate problem-solving method to more general or specific methods, be once you have a prediction function, you have a way to ‘connect inputs/outputs’, which is a general solution automation workflow intent
other functions that produce a function to solve a general solution automation workflow intent can also be general solution-finding methods that can be alternatives to other problem-solving methods

Apply functions that ‘create/maintain info’ for intents that ‘require more info’ (and the opposite for intents ‘requiring less info’) as an alternate useful structure (the standard info format of ‘info changes’ as opposed to ‘inputs/outputs’ or ‘connections/equivalences/similarities/differences/opposites’) to input/output differences/sequences (as in ‘a sequence of functions that add info’ as a solution-finding interface query, rather than a ‘sequence of input-output connections/differences’), since problems are often adjacently formatted as a ‘missing info’ problem, so ‘functions that add info’ are a particularly useful solution structure

Apply reasons to use/not use structures as a filter of structures to use for a solution
example: the reason you don't want to use just rewards/costs is because if they have errors (which they're likely to have), the solution fails
   identify other structures that can cause the entire solution to fail if they have errors, which make a solution fragile
if multiple structures produce the same results, you need a structure that produces different results as a backup/alternative handler of differences, in case it has a reason to change (find the reasons a prediction function would change, or ‘change causes’ and apply them as a reason to add a change handler to a solution)

Integrate other sources of certainty than ‘an update function’ with a solution, so it applies interface analysis to generate a specific solution generator for a problem, rather than the general solution-generator that is interface analysis used to automate problem-solving:
rules of optimization & certainty-development like:
   build from understanding (meaning interface) first, rather than building to get understanding
      new information & rules discovered should usually sync with previous information & rules & other interface structures, as there is rarely a discovery that requires a change to many/all known rules, and these discoveries follow patterns & rules as well (like that ‘changes develop on interfaces that can contain them’ and ‘changes follow change patterns/rules & comply with other change interface structures like change components’)
   build in learning/update functionality at every point to allow injection of new information to correct understanding & understanding-derivation/generation/finding methods
   build in functionality to assess the comparable reasons a solution/prediction/answer is right/wrong
      this is to filter out solutions that have more reasons it could be wrong compared to other solutions or compared to reasons it could be right (like being ‘possible’ with known rules)
   build in functionality to evaluate the probable error types & cost of those error types for any given solution, compared to other solutions, and rules to minimize error costs (like generalization, updating quickly with new information, identifying the reasons for contradictory/confirming information, identifying sources of bias & other error types, etc.)
   build in functionality to evaluate solvability & resources required to solve a problem before solving it, compared to its possible solution's value
so that the system can do other operations than just ‘make a prediction of a variable interaction function’, like:
   predicting updates to their prediction function
      by understanding that the differences in data sets & prediction functions follow patterns with varying success, and that ml is a pattern-identification tool (creating an ‘intent’ or ‘input/output’ or ‘structural’ match between the problem structure & a solution to resolve it), ml can be applied to predict how a particular algorithm will create a prediction function from a data set, given patterns of differences between inputs/outputs of a particular algorithm/parameters/network applied to a data set, and given how ml is applied in similar cases like with complex data sets of many variables that vary on subtle differences that humans are often unable to identify, or on understanding that humans haven't built in that domain yet
      by understanding that the types of problems humans find difficult is likely to mimic the meaning & understanding & other interface components of other systems, ml can be applied to check for patterns of those structures first as an initial filter
   predicting error types & costs of a solution
      understanding can generate error types of a prediction function like specificity, and these error types can be integrated into a solution with more certainty sources & types built in
   predicting solution structures, variables, & optimal implementations
      understanding can identify:
         patterns in prediction functions (which make them easier to check/generate/find/derive)
         the standard attributes & structures of prediction functions, which can act as solution filters/structures, and the reasons why these are standard solution attributes/structures (an average is a standard solution structure of a prediction function because of the cross-system insight rule that ‘variation typically occurs around a symmetry, like an average’)
         continuity, conditional subsets/alternates, averages, specificity, & probability distribution
         interface structures of prediction functions
         sub-interfaces, assumptions, examples, contradictions, errors, causes, concepts, intents, logic, & probable changes
         solution structures like topologies of solution variables that have peaks at optimal solutions, or solution components/inputs/requirements
      identifying whether a solution confirms/contradicts existing structures & other sources of certainty, to identify probability of being correct (like whether it has known contradictions or flawed assumptions or uses logical fallacies or implications rather than information)
      check that predictions/solutions from various certainty sources match up with each other, as an additional certainty structure, given that other certainty sources are integrated & can be applied, either as solution generators/filters/verifiers
      identify that the host system where a prediction function is being injected can be used to verify the prediction function, so if that information is available it can be used instead of the original data set
   this applies interface analysis & specifically the understanding/meaning interface to a specific solution (as opposed to building a general solution-finding/deriving/generating/applying system implementing interface analysis)
      so a prediction function for example would have:
         an ‘information injection’ structure to integrate new information like ‘online learning’)
         functionality to split itself into subset functions or alternate functions when it identifies that different functions are required
         a prediction function to predict its own changes
         a reason (intent/cause/meaning) for its own structures, like that it complies with other known rules or fits into other known systems
         a set of interface structures that it uses as understanding of the variable system, like variable types, variable interaction types, and variable structures like combinations/alternates, and may apply other methods like ml or concepts like randomness/outliers/change to reduce any remaining uncertainties

Apply other changes/differences (like ‘opposites’ or ‘gaps’) (or patterns/generative functions of changes/differences) of error or error-relevant (like ‘sub-optimal solution’ structures) to identify what is not a solution & differentiate from it to find solutions
finding the ‘gaps’ in sub-optimal solutions identifies spaces where optimal solutions can exist by definition
this provides a different target when solving a problem (a solution filter that enables adjacently identifying multiple optimal solutions, once applied) than aiming for the solution itself

Apply specific useful system concepts like ‘democracy’ or ‘freedom’ to problem systems given their usefulness for general problem-solving intents like ‘organization’ (of a neural net architecture or another problem system)
example: apply it to the ml system to generate networks where a node can do whatever processing it wants, as long as its output doesn't contradict another node's processing functions and its output contributes to the global intent and doesn't require more default processing inputs/functions than other nodes
these useful structures can be found with connection sequences to problem-solving intents
   example: for the problem-solving intent of ‘organization’, the connecting structure would be ‘government’, which organizes interface structures of a complex ‘society’ system such as ‘info’ like laws & ‘functions’ like law enforcement & defense
      other structures that ‘organize’ interface structures could also be possible connecting structures to useful system-specific or abstract concepts related to those organizing structures
      the same applies for other problem-solving intents than ‘organization’

Find/generate/derive & apply structures where they are determined to be useful by some structure of usefulness
the structures are known to fulfill an intent, given the known intent of the structure
the structures are/generate/derive/identify either inputs to subsequent functions, or outputs of the function itself
example: the combination of ‘freedom’ & ‘interactions’ is a useful structures to ‘generate difference’ to fulfill intents like ‘resolve uncertainties’ bc of the structure of usefulness ‘find/generate/derive inputs’ (to the ‘resolve uncertainties’ intent, bc if you have a way to generate differences, you can test if these differences explain the uncertain/complex system, so ‘differences’ are an input to that intent and anything that generates an input to that intent is a useful structure)

Apply error structures to known standard/sub-optimal solutions to account for & correct probable errors in known standard/sub-optimal solutions (which can be bad guesses/approximations, so hardly a solution but still a useful origin structure to base changes on)
apply error & change structures to error structures to generate solution structures (the opposite of an error is a solution)
apply variable & error structures to interaction structures (like between input variables, interim variables like weights, or processing functions) to account for errors in their interactions, generate possible interaction structures connecting them, and generate alternative structures to filter out
   weights are an interim structure that can be an input to the solution so they can be treated as variables to analyze on a secondary basis
example:
   apply rules of variable interactions like ‘high variation variables are likely to be found together or in a connection structure, unless some distribution structure occurs between them to distribute variance’ to weights, inputs, network layers, etc.
   apply error structures like ‘opposite’ of the correct value to existing variable values to generate alternates to filter or form an alternative base
apply change & error structures to structures of standards to generate possible solution structures if the structures of standards don't fulfill solution metrics

Apply difference patterns in how solutions change with different info to:
identify whether the minimum info to reach a optimal solution is available
generate changes to existing solutions to test if their change patterns match changes in solutions with different info in a way that leads to an optimal solution

Apply connection structures to connect useful structures so other useful structures can be found/derived/generated from input useful structures which may be more adjacent to the problem space structures
example: find connection/difference patterns between structures like the following, so that either can be generated from the other:
   requirements & vertex variables
   efficiencies & ambiguities
   expectations/predictions & outcomes
   problem/solution structures
   filter input/output (solution space & solution)
   solution components & solutions
connection structures/interim states & problem/solution structures
   applying pattern & difference-identification algorithms to interim states between problems/solutions generated by other solution functions to identify patterns that solutions typically take and connections between interim states to reduce the time to generate interim states & solutions (like weight path patterns in an ml network are an ‘interim state’ of the input data while its being converted to a solution), and so these interim states & solutions can be generated without the original tools used to generate them (for the same problem or other problems)

Find combination of interface structures (like change types/sequences) that creates a topology of solution optimization that can be navigated with methods of finding global minima/maxima
generalization: apply other interface structures that can solve a relevant problem (like ‘finding a maximum value’) once info is formatted in a particular structure (like a function or topology), and convert problem system info (like possible solutions) to that input structure, optionally using interface structures (like solution filters to reduce possible solutions), as a way of applying the ‘input-output sequence’ structure using useful functions on various interfaces
example: cluster analysis to ‘identify similar solutions of different types’ is another example

Different origin/inputs/data can produce a solution faster, even invalidating any update/learning process (if you have the right info, a solution may be obvious and no learning is required, as your data is optimized so no learning optimization is required)
what info is stored in memory matters, and the learning rules used to update it or the alternatives like understanding that can be used to replace it, but the format in which info is stored also matters
   info stored in a non-findable way is not useful, just like repeated info is not useful
   this can be thought of as the corollary (or pre-requisite to/invalidator of) of ‘input data optimizations’, as ‘output data optimizations’ before storage, so that info is stored in a way that maximizes its usefulness for future uses/intents
   ‘data processing optimizations’ is another position where optimization structures can be added to optimize other intents like learning/understanding/finding
apply data optimizations (pre-processing) to find/create optimal data to reduce learning requirements
   prioritize rules that generate or form a basis for other rules, like physics rules, so any info that reveals physics rules is highly prioritized
   this includes rules like ‘apply change patterns & other change structures to data that typically produce solutions’
understanding based on meaning can also reduce learning requirements
   applying interface analysis to identify useful interface structures like ‘probable variable interaction structures’ or ‘approximate variable interaction structures’ improves the probability of a successful variable interaction prediction function, which is based on the insights that reflect understanding & reduce the requirement to learn a new function with no understanding, which interacts with the meaning of these structures
      ‘probability is a relevant concept to prediction’
      ‘variable interactions follow patterns so they have corresponding probabilities’
      ‘approximation is a relevant concept to prediction’
      ‘approximations are related to predictions in the form of “minimal difference”’
anything that can find/derive/generate understanding or find/generate/derive optimized data can also act as an alternative to learning, understanding, or optimized data, with varying success rates
   for example, a known solution database may act as an alternative
   a rules database of known interactions may act as an alternative to a meaning-deriving/finding/applying/generating function
these are static alternatives so are likelier to be sub-optimal, so other structures of optimization (like generalization, or generating causes/inputs rather than original components) should be applied
   an alternative that can update itself is by definition likelier to be optimal
      an alternative that can find/generate/derive/apply itself is likelier to be optimal
         an alternative that can find/generate/derive/apply components/inputs of itself is likelier to be optimal
         an alternative that can find/generate/derive/apply components/inputs of anything (including other alternatives) is likelier to be optimal
         an alternative that can find/generate/derive/apply components/inputs of find/generate/derive/apply functions is likelier to be optimal
why is it important to have alternatives to learning functions/structures?
   be learning structures usually use some form of reward/cost to identify information that is more valuable, given information that was previously valuable
   but rewards/costs that are specific to solving one particular problem is how bias develops, so learning functions will inevitably produce errors some of the time
this is why its important to have other interface structures in place, which can identify alternatives that could contradict/neutralize/prevent bias from developing
this interface structure can be another function network, or a parameterized bias-assignment function that changes learning costs/rewards to avoid bias development
other examples:
   change-function interface structures: function network with updated weights to indicate prioritized useful info (ml)
   cause-function interface structures: cause-identifying/generating/deriving function, generative functions in general
   potential-structure-logic-function interface structure: applying logic to rules about what is possible to create filter functions to filter out impossibilities in the solution space of possible solution functions

Apply differences in problem structures as a filter of solutions (solutions to different problems have to have a correlated level of difference in the solution)

One skilled in the art, after reviewing this disclosure, may recognize that modifications, additions, or omissions may be made to the solution automation module 140 without departing from the scope of the disclosure. For example, the designations of different elements in the manner described is meant to help explain concepts described herein and is not limiting. Further, the solution automation module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component in this disclaimer is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method optionally comprising relating solution automation & interface analysis variables such as the following:
function types
general functions like find/apply/cause/intend/build/mean
interim cross-interface functions like organize/standardize
core interaction functions like connect/reduce/combine
problem-solving intent functions like ‘filter a solution space’
interface operation functions like ‘apply the causal interface to the pattern interface to find “causes of patterns”’ & interface-query-building functions executing logic like ‘derive multiple interface queries & execute them in parallel until one is clearly contributing, then continue that query’
vertex functions like generative/describing/determining/causing/differentiating functions
solution automation workflows & their variables (like workflow fit, alternate versions, variable interactions, core/component/differentiating/input/output/vertex variables, interface variables like ‘cause’ and ‘success cause’ and useful structure variables like ‘generative functions of workflows’)
interface queries implementing solution automation workflows & their variables
useful structures like ‘alternate routes’, ‘generative functions’ & ‘optimizations’
problem/solution structures like ‘error types’ & ‘solution metrics/requirements’

2. The method of claim 1, wherein example variables of solution automation & interface analysis are related with rules like ‘one variable applies the other variable’, ‘one variable can generate the other variable’, etc.

3. The method of claim 1, wherein example variables of solution automation & interface analysis include various function types, like general functions, cross-interface functions, core interaction functions, problem-solving intent functions, interface operation & query design functions, and vertex functions.

4. The method of claim 1, wherein example variables of solution automation & interface analysis include variables of these variables so they can be interacted with (identified/derived/applied/generated) as needed, like how ‘solution success cause’ is a variable of ‘solution automation workflows’ and ‘interface queries’ because they are directly relevant to solutions.

5. The method of claim 1, wherein example implementations of problem/solution components (like example ‘solution automation workflows’) involve interface structures like ‘cause’, functions types like ‘generative functions’ & useful structures like ‘alternatives’ & ‘errors’.

6. A non-transitory computer-readable medium containing instructions that, when executed by a processor, cause a device to perform operations, the operations comprising relating solution automation & interface analysis variables such as the following:
function types
general functions like find/apply/cause/intend/build/mean
interim cross-interface functions like organize/standardize
core interaction functions like connect/reduce/combine
problem-solving intent functions like ‘filter a solution space’
interface operation functions like ‘apply the causal interface to the pattern interface to find “causes of patterns”’ & interface-query-building functions executing logic like ‘derive multiple interface queries & execute them in parallel until one is clearly contributing, then continue that query’
vertex functions like generative/describing/determining/causing/differentiating functions
solution automation workflows & their variables (like workflow fit, alternate versions, variable interactions, core/component/differentiating/input/output/vertex variables, interface variables like ‘cause’ and ‘success cause’ and useful structure variables like ‘generative functions of workflows’)
interface queries implementing solution automation workflows & their variables
useful structures like ‘alternate routes’, ‘generative functions’ & ‘optimizations’
problem/solution structures like ‘error types’ & ‘solution metrics/requirements’

7. The non-transitory computer-readable medium of claim 6, wherein example variables of solution automation & interface analysis are related with rules like ‘one variable applies the other variable’, ‘one variable can generate the other variable’, etc.

8. The non-transitory computer-readable medium of claim 6, wherein example variables of solution automation & interface analysis include various function types, like general functions, cross-interface functions, core interaction functions, problem-solving intent functions, interface operation & query design functions, and vertex functions.

9. The non-transitory computer-readable medium of claim 6, wherein example variables of solution automation & interface analysis include variables of these variables so they can be interacted with (identified/derived/applied/generated) as needed, like how ‘solution success cause’ is a variable of ‘solution automation workflows’ and ‘interface queries’ because they are directly relevant to solutions.

10. The non-transitory computer-readable medium of claim 6, wherein example implementations of problem/solution components (like example ‘solution automation workflows’) involve interface structures like ‘cause’, functions types like ‘generative functions’ & useful structures like ‘alternatives’ & ‘errors’.

11. A system comprising: one or more processors; and one or more non-transitory computer-readable media containing instructions that, when executed by the one or more processors, cause the system to perform operations, the operations comprising relating solution automation & interface analysis variables such as the following:
function types
general functions like find/apply/cause/intend/build/mean
interim cross-interface functions like organize/standardize
core interaction functions like connect/reduce/combine
problem-solving intent functions like ‘filter a solution space’
interface operation functions like ‘apply the causal interface to the pattern interface to find “causes of patterns”’ & interface-query-building functions executing logic like ‘derive multiple interface queries & execute them in parallel until one is clearly contributing, then continue that query’
vertex functions like generative/describing/determining/causing/differentiating functions
solution automation workflows & their variables (like workflow fit, alternate versions, variable interactions, core/component/differentiating/input/output/vertex variables, interface variables like ‘cause’ and ‘success cause’ and useful structure variables like ‘generative functions of workflows’)
interface queries implementing solution automation workflows & their variables
useful structures like ‘alternate routes’, ‘generative functions’ & ‘optimizations’
problem/solution structures like ‘error types’ & ‘solution metrics/requirements’

12. The system of claim 11, wherein example variables of solution automation & interface analysis are related with rules like ‘one variable applies the other variable’, ‘one variable can generate the other variable’, etc.

13. The system of claim 11, wherein example variables of solution automation & interface analysis include various function types, like general functions, cross-interface functions, core interaction functions, problem-solving intent functions, interface operation & query design functions, and vertex functions.

14. The system of claim 11, wherein example variables of solution automation & interface analysis include variables of these variables so they can be interacted with (identified/derived/applied/generated) as needed, like how ‘solution success cause’ is a variable of ‘solution automation workflows’ and ‘interface queries’ because they are directly relevant to solutions.

15. The system of claim 11, wherein example implementations of problem/solution components (like example ‘solution automation workflows’) involve interface structures like ‘cause’, functions types like ‘generative functions’ & useful structures like ‘alternatives’ & ‘errors’.
